(19) United States
(12) Patent Application Publication
(10) Pub. No.: US 2024/0367347 A1
(43) Pub. Date: Nov. 7, 2024

(54) CONCRETE MIXER VEHICLE WITH IDLE REDUCTION

(71) Applicant: Oshkosh Corporation, Oshkosh, WI (US)

(72) Inventors: Eric Wall, Oshkosh, WI (US); David Anderson, Oshkosh, WI (US); Andrew Glaeser, Oshkosh, WI (US)

(73) Assignee: Oshkosh Corporation, Oshkosh, WI (US)

(21) Appl. No.: 18/652,505

(22) Filed: May 1, 2024

Related U.S. Application Data
(60) Provisional application No. 63/463,499, filed on May 2, 2023.

(51) Int. Cl. B28C 5/42

(52) U.S. Cl. CPC B28C 5/422; B28C 5/4248; B28C 5/4272

(57) ABSTRACT

A concrete mixer vehicle includes a controller that is configured to detect that an engine is in an idle condition and selectively shutdown the engine in response to detecting that one or more override conditions are met.

### CROSS-REFERENCE TO RELATED PATENT APPLICATIONS

This application claims the benefit of and priority to U.S. Provisional Patent Application No. 63/463,499, filed on May 2, 2024, the entire disclosure of which is hereby incorporated by reference herein.

### BACKGROUND

Concrete mixer vehicles are configured to receive, mix, and transport wet concrete or a combination of ingredients that when mixed form wet concrete to a job site. Concrete mixer vehicles include a rotatable mixing drum that receives concrete poured from vehicles or from stationary facilities, such as concrete mixing plants, and mixes the concrete disposed therein. Concrete mixer vehicles may be front discharge concrete mixer vehicles or rear discharge concrete mixer vehicles, which dispense concrete from the front or rear thereof, respectively. Rear discharge concrete mixer vehicles generally feature a drum with an outlet positioned at an aft end and a cab enclosure positioned at a fore end of the concrete mixer truck. Front discharge concrete mixer vehicles include a drum with an outlet supported above the cab enclosure of the concrete mixer vehicle to discharge concrete through a chute extending forward the concrete mixer vehicle. Because front discharge concrete mixer vehicles discharge concrete at the fore end, they can be used to supply concrete to locations having limited access.

### SUMMARY

One embodiment relates to a concrete mixer vehicle. The concrete mixer vehicle includes a chassis, an engine coupled to the chassis, a front axle coupled to the chassis, a rear axle coupled to the chassis, a cab coupled to the chassis, the cab defining an interior compartment, a drum assembly coupled to the chassis, and a hopper actuator positioned to move the charge hopper between a first position and a second position. The drum assembly includes a mixing drum defining an aperture and an internal volume, a charge hopper positioned proximate the aperture, and a chute positioned proximate the aperture, beneath the charge hopper. The first position facilitates loading materials into the internal volume of the mixing drum via the charge hopper through the aperture, and the second position facilitates discharging the materials from the internal volume, through the aperture, and to the chute. The concrete mixer vehicle further includes a controller in communication with the engine, the drum assembly, and the hopper actuator. The controller is configured to detect that the engine is in an idle condition and selectively shutdown the engine in response to determining that one or more override conditions are met.

One embodiment relates to a concrete mixer vehicle. The concrete mixer vehicle includes a chassis, an engine coupled to the chassis, a front axle coupled to the chassis, a rear axle coupled to the chassis, a cab coupled to the chassis, the cab defining an interior compartment, a drum assembly coupled to the chassis, and a hopper actuator positioned to move the charge hopper between a first position and a second position. The drum assembly includes a mixing drum defining an aperture and an internal volume, a charge hopper positioned proximate the aperture, and a chute positioned proximate the aperture, beneath the charge hopper. The first position facilitates loading materials into the internal volume of the mixing drum via the charge hopper through the aperture, and the second position facilitates discharging the materials from the internal volume, through the aperture, and to the chute. The concrete mixer vehicle further includes a controller in communication with the engine, the drum assembly, and the hopper actuator. The controller is configured to detect that the engine is in an idle condition and initiate an idle shutdown process where the engine is selectively shutdown in response to determining that idle shutdown conditions are met. The idle shutdown conditions include (a) a slump pressure being below a slump pressure threshold, (b) a speed of the mixing drum is between a lower speed threshold and an upper speed threshold, and (c) the main chute and the extension chute are in a storage configuration.

One embodiment relates to an idle shutdown method for a concrete mixer vehicle. The idle shutdown method includes detecting that an engine is in an idle condition, determining if idle shutdown conditions are met, and in response to determining that the idle shutdown conditions are met, shutting down the engine. The idle shutdown conditions include (a) a slump pressure being below a slump pressure threshold, (b) a speed of a mixing drum is between a lower speed threshold and an upper speed threshold, and (c) a main chute and an extension chute are in a storage configuration.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view of a concrete mixer truck, according to an exemplary embodiment;

FIG. 2 is a front perspective view of the concrete mixer truck of FIG. 1, according to an exemplary embodiment;

FIG. 3 is a rear perspective view of the concrete mixer truck of FIG. 1, according to an exemplary embodiment;

FIG. 4 is a block diagram of a body controller and an engine controller of the vehicle of FIG. 1, according to an exemplary embodiment;

FIG. 5 is a schematic illustration of a restart process in response to detection of a restart condition, according to an exemplary embodiment;

FIG. 6 is a schematic illustration of a restart process in response to detection of a driver interaction, according to an exemplary embodiment;

FIG. 7 is a schematic illustration of a restart process in response to detection of an ignition key, according to an exemplary embodiment; and

FIG. 8 is a flowchart outlining the steps in an idle shutdown process or method, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a concrete mixer vehicle may include a controller that is configured to reduce an amount of time that the vehicle spends at idle during a workday. By way of example, a concrete mixer vehicle may spend upwards of 50% of the time at idle during a working day, which results in significant fuel consumption. The controller may be configured to perform a controlled shutdown of the concrete mixer vehicle, from idle, when a predefined shutdown criteria is met.

### Overall Vehicle

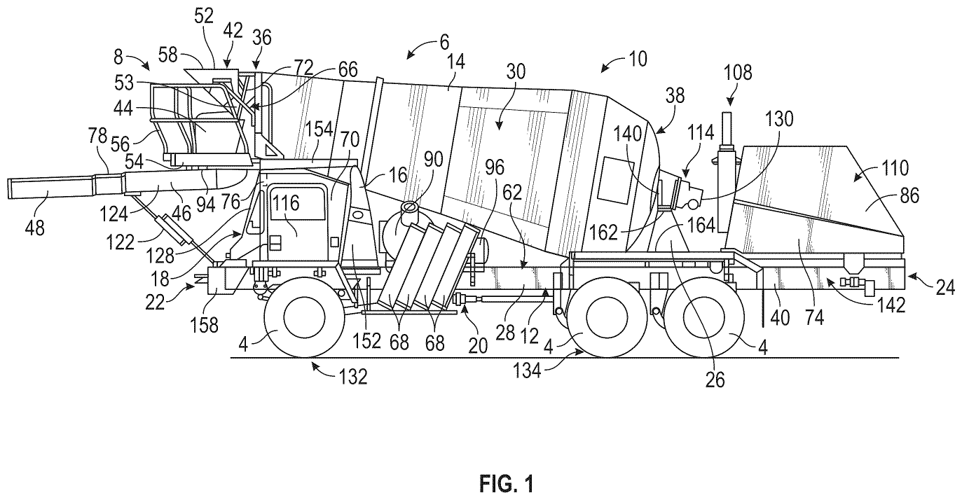

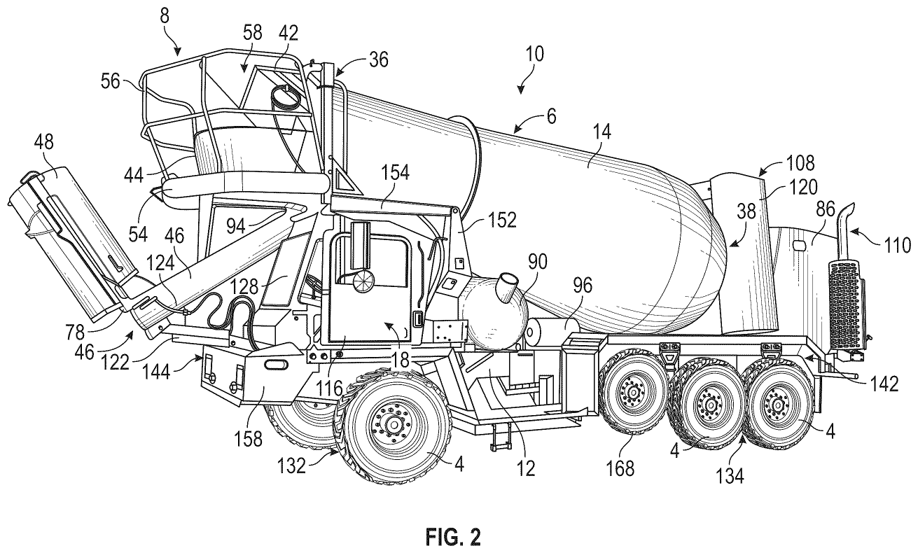

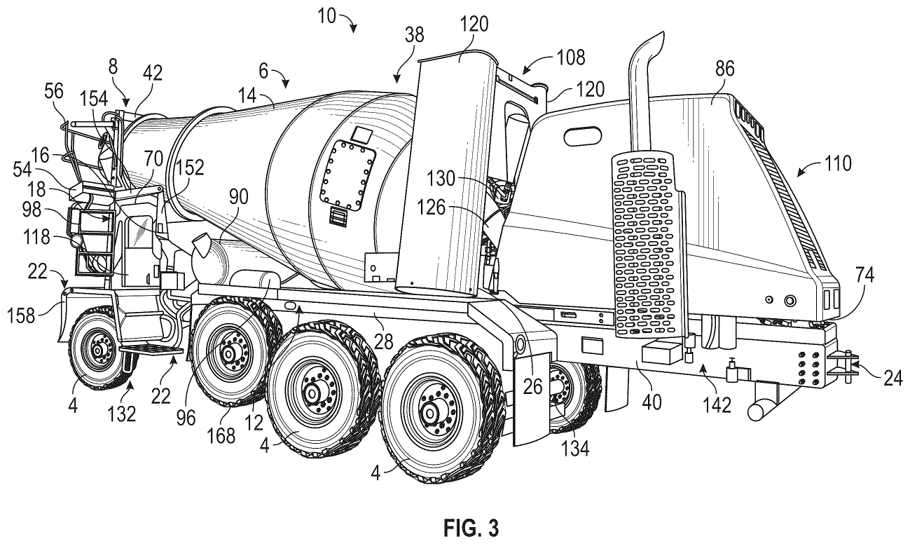

According to the exemplary embodiment shown in FIGS. 1-3, a vehicle, shown as concrete mixer truck 10, is configured to transport concrete from a loading location (e.g., a batching plant, etc.) to a point of use (e.g., a worksite, a construction site, etc.). In some embodiments, as shown in FIGS. 1-3, the concrete mixer truck 10 is a front discharge concrete mixer vehicle. In other embodiments, the concrete mixer truck 10 is a rear discharge concrete mixer vehicle. The concrete mixer truck 10 includes a chassis 12, a drum assembly 6, a hopper assembly 8, a drive system 20, a fuel system 108, and an engine module 110. The concrete mixer truck 10 may include various additional engine, transmission, drive, electronic, tractive assembly, braking, steering and/or suspension systems, and hydraulic systems that are configured to support the various components of the concrete mixer truck 10. Generally, the chassis 12 supports a mixing drum 14 of the drum assembly 6, a front pedestal 16, a rear pedestal 26, a cab 18, and the engine module 110. Each of the chassis 12, the drum assembly 6, the hopper assembly 8, the drive system 20, the fuel system 108, and the engine module 110 are configured to facilitate receiving, mixing, transporting, and delivering concrete to a job site via the concrete mixer truck 10.

The chassis 12 includes a frame 28 that extends from a front end 22 to a rear end 24 of the concrete mixer truck 10. Wheels 4 are coupled to the frame 28 and moveably support the frame 28 above a ground surface or road. The wheels 4 may be replaced by other ground engaging motive members, such as tracks. In some embodiments, the chassis 12 includes hydraulic components (e.g., valves, filters, pipes, hoses, etc.) coupled thereto that facilitate operation and control of a hydraulic circuit including a drum drive pump and/or an accessory pump. The frame 28 provides a structural base for supporting the mixing drum 14, the front pedestal 16, the rear pedestal 26, the cab 18, and the engine module 110. In some embodiments, the frame 28 includes a widened front portion that extends over and about the wheels 4 positioned at the front end 22 of the chassis 12 to simultaneously support the cab 18 and serve as a fender for the wheels 4 positioned at the front end 22 of the chassis 12. The frame 28 may include lift eyes or other structures that facilitates lifting along the chassis 12 such that the chassis 12 can be manipulated as a subassembly for assembly and/or maintenance of the concrete mixer truck 10. One or more components may be coupled to the chassis 12 using isolating mounts made of a complaint material, such as rubber. The isolating mounts may be configured to reduce the transfer of vibrations between the components and the chassis 12.

The frame 28 includes a pair of frame rails 40 coupled with intermediate cross members, according to an exemplary embodiment. The frame rails 40 extend in a generally-horizontal and longitudinal direction (e.g., extend within 10 degrees of perpendicular relative to a vertical direction, extend within ten degrees of parallel relative to a ground surface when concrete mixer truck 10 is positioned on flat ground, etc.) between the front end 22 and the rear end 24. The frame rails 40 may be elongated “C-channels” or tubular members, according to various exemplary embodiments. In other embodiments, the frame rails 40 include another type of structural element (e.g., monocoque, a hull, etc.). In still other embodiments, the frame rails 40 include a combination of elongated C-channels, tubular members, a monocoque element, and/or a hull element. A first frame rail 40 may be disposed along a first lateral side 142 and a second frame rail 40 may be disposed along a second lateral side 144, respectively, of the concrete mixer truck 10. By way of example, the first lateral side 142 of the chassis 12 may be the left side of the concrete mixer truck 10 (e.g., when an operator is sitting in the cab 18 and positioned to drive the concrete mixer truck 10, etc.) and the second lateral side 144 of the chassis 12 may be the right side of the concrete mixer truck 10 (e.g., when an operator is sitting in the cab 18 and positioned to drive the concrete mixer truck 10, etc.).

The cab 18 is coupled to the frame rails 40 proximate the front end 22 of the chassis 12. According to various embodiments, the cab 18 (e.g., operator cabin, front cabin, etc.) is configured to house one or more operators during operation of the concrete mixer truck 10 (e.g., when driving, when dispensing concrete, etc.), and may include various components that facilitate operation and occupancy of the concrete mixer truck 10 (e.g., one or more seats, a steering wheel, control panels, screens, joysticks, buttons, accelerator, brake, gear lever, etc.). The cab 18 includes a housing 70 that forms the structure of the cab 18. At least one door 116 is affixed to the housing 70 to allow an operator to enter and exit the cab 18. A windshield 128 is disposed along a front side of the housing 70, near the front end 22, and above a front bumper 158 of the concrete mixer truck 10. The windshield 128 is configured to provide visibility to the operator while driving the concrete mixer truck 10, operating a main chute 46, and completing other tasks. The front bumper 158 may be affixed to a bottom portion of the housing 70. In some embodiments, the front bumper 158 is affixed to the frame 28 at the front end 22 of the concrete mixer truck 10.

A control assembly 76 is disposed within the cab 18 and is configured to control one or more components of the concrete mixer truck 10. The control assembly 76 may include controls, buttons, joysticks, and other features that control the movement and orientation of the concrete mixer truck 10, the hopper assembly 8, the main chute 46, a charge hopper 42, a discharge hopper 44, the mixing drum 14, and/or other components of the concrete mixer truck 10. For example, the control assembly 76 may include overhead controls (e.g., in a forward overhead position) that allow an occupant of the cab 18 to toggle a switch from a ‘Close’ position to an ‘Open’ position to open and close the charge hopper 42 and/or the discharge hopper 44. In some embodiments, the control assembly 76 includes a user interface with a display and an operator input. The display may be configured to display a graphical user interface, an image, an icon, or still other information. In one embodiment, the display includes a graphical user interface configured to provide general information about the concrete mixer truck 10 (e.g., vehicle speed, fuel level, warning lights, etc.). The graphical user interface may also be configured to display a current mode of operation, various potential modes of operation, or still other information relating to a transmission, modules, the drive system 20, and/or other components of the concrete mixer truck 10.

An air tank 96 is coupled to and supported by the chassis 12 and positioned directly beneath the mixing drum 14. The air tank 96 is configured to store compressed air (e.g., for use in an air brake system, for use when raising and lowering a pusher axle assembly, etc.). A water tank 90 extends laterally across the length of the chassis 12, forward of the air tank 96. The water tank 90 is coupled to the frame rails 40 and positioned beneath the mixing drum 14. The water tank 90 may be coupled to a water pump that is used to supply water from the water tank 90 to wash the concrete mixer truck 10 after pouring a concrete load and/or to add water to the concrete within the mixing drum 14 at the construction site and/or during transit, among other uses.

The drum assembly 6 is configured to store, mix and dispense concrete. The drum assembly 6 includes the mixing drum 14, a drum driver 114, and the hopper assembly 8. The mixing drum 14 extends longitudinally along a majority of the length of concrete mixer truck 10 and may be angled relative to the frame rails 40 (e.g., when viewed from the side of concrete mixer truck 10). The mixing drum 14 has a first end 36 that is positioned toward the front end 22 of the concrete mixer truck 10 and coupled to the front pedestal 16 (e.g., support post, support column, etc.). The first end 36 may at least partially extend over the cab 18. The first end 36 defines a drum opening 72 in communication with the hopper assembly 8 through which concrete may flow (e.g., between the charge hopper 42, the mixing drum 14, the discharge hopper 44, the main chute 46, and extension chutes 48, etc.). The mixing drum 14 has a second end 38 that is positioned toward the rear end 24 of the concrete mixer truck 10 and coupled to the rear pedestal 26 (e.g., support post, support column, etc.). The mixing drum 14 may be rotatably coupled to front pedestal 16 (e.g., with a plurality of wheels or rollers, etc.) and rear pedestal 26 (e.g., with a drum drive transmission, etc.). Each of the front pedestal 16 and the rear pedestal 26 may be a part of a superstructure of the concrete mixer truck 10. The superstructure further includes the frame 28 and the chassis 12. In other embodiments, the mixing drum 14 is otherwise coupled to the frame rails 40. Although the concrete mixer truck 10 illustrated in FIGS. 1-3 is a front discharge concrete mixer vehicle, it is to be understood that in other embodiments the concrete mixer truck 10 may include a drum assembly 6 having any other discharge arrangement (e.g., rear discharge).

The front pedestal 16 includes an upper portion 152 and a lower portion 154. The upper portion 152 is coupled to and supports the hopper assembly 8. The lower portion 154 is coupled to the frame rails 40 and supports the upper portion 152 of the front pedestal 16 and the first end 36 of the mixing drum 14. The rear pedestal 26 includes an upper portion 162 and a lower portion 164. The lower portion 164 is coupled to the frame rails 40 and supports the upper portion 162. The upper portion 162 supports a bottom interface of a drum drive transmission 140 (e.g., a bottom portion of the housing thereof) and/or the second end 38 of the mixing drum 14. In some embodiments, the rear pedestal 26 includes a pair of legs extending between the frame rails 40 and the drum drive transmission 140.

The drum opening 72 at the first end 36 of the mixing drum 14 is configured to receive a mixture, such as a concrete mixture, or mixture ingredients (e.g., cementitious material, aggregate, sand, etc.) such that the mixture can enter and exit an internal volume 30 of the mixing drum 14. The mixing drum 14 may include a mixing element (e.g., fins, etc.) positioned within the internal volume 30. The mixing element may be configured to (i) agitate the contents of mixture within the mixing drum 14 when the mixing drum 14 is rotated in a first direction (e.g., counterclockwise, clockwise, etc.) and (ii) drive the mixture within the mixing drum 14 out through the drum opening 72 when the mixing drum 14 is rotated in an opposing second direction (e.g., clockwise, counterclockwise, etc.). During operation of the concrete mixer truck 10, the mixing elements of the mixing drum 14 are configured to agitate the contents of a mixture located within the internal volume 30 of the mixing drum 14 as the mixing drum 14 is rotated in a counterclockwise and/or a clockwise direction by the drum driver 114.

The drum driver 114 is configured to provide an input (e.g., a torque, etc.) to the mixing drum 14 to rotate the mixing drum 14 relative to the chassis 12. The drum driver 114 may be configured to selectively rotate the mixing drum 14 clockwise or counterclockwise, depending on the mode of operation of the concrete mixer truck 10 (i.e., whether concrete is being mixed or dispensed). The drum driver 114 is coupled to a rear or base portion of the second end 38 of the mixing drum 14 and a top end of the lower portion 164 and/or a lower end of the upper portion 162 of the rear pedestal 26. The drum driver 114 includes a transmission, shown as drum drive transmission 140, and a driver, shown as drum drive motor 130, coupled to drum drive transmission 140. The drum drive transmission 140 extends rearward (e.g., toward the rear end 24 of the concrete mixer truck 10, toward the engine module 110, etc.) from the second end 38 of mixing drum 14 and the drum drive motor 130 extends rearward from drum drive transmission 140. In some embodiments, the drum drive motor 130 is a hydraulic motor. In other embodiments, the drum drive motor 130 is another type of actuator (e.g., an electric motor, etc.).

The drum drive motor 130 is configured to provide an output torque to the drum drive transmission 140, according to an exemplary embodiment, which rotates the mixing drum 14 about a rotation axis. The drum drive transmission 140 may include a plurality of gears (e.g., a planetary gear reduction set, etc.) configured to increase the turning torque applied to the mixing drum 14, according to an exemplary embodiment. The plurality of gears may be disposed within a housing. In some embodiments, a drum drive pump and/or accessory pump may be configured to receive rotational mechanical energy and output a flow of pressurized hydraulic fluid to drive one or more components of the concrete mixer truck 10.

The hopper assembly 8 is positioned at the drum opening 72 of the mixing drum 14. The hopper assembly 8 is configured to introduce materials into and allow the materials to flow out of the internal volume 30 of the mixing drum 14 of the concrete mixer truck 10. The hopper assembly 8 is configured to prevent loss of material or spillage when the material enters and exits the mixing drum 14. The hopper assembly 8 includes the charge hopper 42, the discharge hopper 44, a hopper actuator 66, a platform 54, and the main chute 46, which are positioned above at least partially forward of the cab 18 of the concrete mixer truck 10. The charge hopper 42 is configured to direct the materials (e.g., cement precursor materials, etc.) into the drum opening 72 of the mixing drum 14. The discharge hopper 44 is configured to dispense mixed concrete from the internal volume 30 of the mixing drum 14 to the main chute 46 and, ultimately, the desired location.

The platform 54 includes a perforated surface that surrounds the charge hopper 42 and the discharge hopper 44. In some embodiments, the platform 54 includes an asymmetric base. The platform 54 includes platform sides extending beneath the perforated surface. A guardrail 56 is coupled to the platform 54 and follows the contour of a periphery of the platform 54. The platform 54 is situated at a position near the drum opening 72 of the mixing drum 14 to facilitate access by the operator to the drum opening 72, the internal volume 30, the charge hopper 42, the discharge hopper 44, and/or the main chute 46. In some embodiments, the concrete mixer truck 10 includes a ladder 98 that extends downward from a side of the platform 54 to allow an operator to climb and reach the platform 54.

The charge hopper 42 includes a first portion 52 that is configured to receive materials during a charging/loading operation. The first portion 52 has a rim 58 (e.g., opening) formed at a free end of the first portion 52. The charge hopper 42 includes a second portion 53 aligned with the bottom of the first portion 52. According to an exemplary embodiment, the charge hopper 42 is selectively repositionable/movable. In some embodiments, the charge hopper 42 is configured to rotate about a horizontal, lateral axis. In some embodiments, the charge hopper 42 is configured to raise and lower vertically. Specifically, the charge hopper 42 is configured to lift, pivot, or otherwise move between a first position (e.g., a lowered position, loading position, a charging position, etc.) and a second position (e.g., a raised position, a dispensing/discharging position, a pivoted position, etc.) above or shifted from the first position. In the first position, the charge hopper 42 is configured to direct material (e.g., concrete, etc.) from a source positioned above the concrete mixer truck 10 (e.g., a batch plant, etc.) through the drum opening 72 and into the internal volume 30 of the mixing drum 14. The first position may also facilitate transport of the concrete mixer truck 10 by lowering the overall height of the concrete mixer truck 10. In the second position, the charge hopper 42 moves (e.g., lifts, pivots, etc.) away from the drum opening 72 and facilitates material flowing unobstructed out of the drum opening 72 and into the discharge hopper 44 and the main chute 46.

A hopper actuator 66 is positioned to move the charge hopper 42 between the first position and the second position. The hopper actuator 66 facilitates selectively controlling movement of the charge hopper 42 between the first position and the second position. The hopper actuator 66 is coupled to and extends between the charge hopper 42 and the platform 54. In some embodiments, the hopper actuator 66 is a hydraulic cylinder. In other embodiments, the hopper actuator 66 is another type of actuators (e.g., a pneumatic cylinder, a lead screw driven by an electric motor, an electric motor, etc.).

When receiving the material, the charge hopper 42 may be in the first position and the main chute 46 may be in a first configuration (e.g., a transport configuration, a stored configuration, etc.). Accordingly, material can be deposited into the charge hopper 42, and the charge hopper 42 directs the material into the internal volume 30 of the mixing drum 14 through the drum opening 72. While material is being added to the mixing drum 14, the drum driver 114 may be operated to drive the mixing drum 14 to agitate the material and facilitate fully loading/packing the mixing drum 14. Alternatively, the mixing drum 14 may be stationary while material is added to the mixing drum 14. When discharging and the charge hopper 42 is in the second position, the discharge hopper 44 funnels material from the mixing drum 14 into the main chute 46.

The main chute 46 functions as an outlet of the mixing drum 14 and is used to direct concrete dispensed from the internal volume 30 of the mixing drum 14 and through the discharge hopper 44 to a target location near the concrete mixer truck 10. The main chute 46 is pivotally coupled to the platform 54 and/or the discharge hopper 44 such that the main chute 46 is configured to rotate about both a vertical axis and a horizontal axis. The main chute 46 includes a base section 124 that may be pivotally coupled to the platform 54 and/or the discharge hopper 44. An extension chute 48 (e.g., a folding section, a second chute section, etc.) is pivotally coupled to the distal end of the base section 124. In some embodiments, a plurality of extension chutes 48 are pivotally connected to one another. One or more removable/detachable extension chutes 68 may be selectively coupled to the distal end of the extension chute 48. The main chute 46 is selectively reconfigurable between a first configuration (e.g., a storage configuration, a transport configuration, etc.) and a second configuration (e.g., a use configuration, a dispensing configuration, etc.). In the first configuration, (i) the base section 124 may be selectively oriented substantially horizontal and extending laterally outward, (ii) the extension chute 48 may be selectively pivoted relative to the base section 124 and extending substantially vertically, and (iii) the removable extension chutes 68 may be removed from the extension chute 48 and stored elsewhere in the concrete mixer truck 10 (e.g., coupled to the chassis 12 beneath the mixing drum 14, etc.). In the first configuration, the main chute 46 may, therefore, minimally obscure the view of an operator positioned within the cab 18. In the second configuration, (i) the extension chute 48 may be pivoted relative to the base section 124 from the substantially vertical orientation to a substantially horizontal orientation such that the base section 124 and the extension chute 48 are aligned with one another to form a continuous path through which material can flow, and (ii) one or more of the removable extension chutes 68 may be coupled to the distal end of the extension chute 48 to increase the length of the main chute 46 (e.g., to distribute concrete further away from the concrete mixer truck 10, etc.).

A first chute actuator 122 (e.g., a chute raising/lowering actuator, etc.) is coupled to and extends between the main chute 46 (e.g., a distal end thereof, etc.) and the chassis 12. In some embodiments, the first chute actuator 122 is extends between the main chute 46 and the front bumper 158. The first chute actuator 122 is configured to raise and lower the main chute 46 to control the orientation of the main chute 46 relative to a horizontal plane (e.g., the ground, etc.). In some embodiments, the first chute actuator 122 is a pair of opposing hydraulic cylinders. In other embodiments, the first chute actuator 122 is another type of actuator (e.g., a pneumatic cylinder, a lead screw driven by an electric motor, a single hydraulic cylinder, etc.). In some embodiments, the first chute actuator 122 and the main chute 46 are both configured to rotate about the same or substantially the same vertical axis (e.g., as the main chute 46 is pivoted about the vertical axis as described in more detail herein).

A second chute actuator 94 (e.g., a chute pivot/rotation actuator, etc.) is coupled to the base section 124 of the main chute 46 and the platform 54. The second chute actuator 94 is configured to rotate the main chute 46 about a vertical axis. The second chute actuator 94 is configured to move the distal end of the main chute 46 through an arc along the left, front, and right sides of the chassis 12 (e.g., a 150 degree arc, a 180 degree arc, a 210 degree arc, etc.). In one embodiment, the second chute actuator 94 is a hydraulic motor. In other embodiments, the second chute actuator 94 is another type of actuator (e.g., a pneumatic motor, an electric motor, etc.).

A third chute actuator 78 (e.g., a chute folding/unfolding actuator, etc.) is configured to reposition (e.g., extend and retract, fold and unfold, etc.) the extension chute 48 relative to the base section 124 of the main chute 46. The third chute actuators 78 may be coupled to and extend between the base section 124 and the extension chute 48. In some embodiments, the third chute actuator 78 includes a plurality of actuators positioned to reposition a first extension chute 48 relative to the base section 124 and one or more second extension chutes 48 relative to the first extension chute 48. The first chute actuator 122, the second chute actuator 94, and the third chute actuator 78 facilitate selectively reconfiguring the main chute 46 between the first configuration and the second configuration. In some embodiments, a controller (e.g., joystick) is configured to facilitate providing commands to control operation of the first chute actuator 122, the second chute actuator 94, and the third chute actuator 78 to direct the main chute 46 and concrete flow therefrom. In some embodiments, a hopper pump may be coupled to the chassis 12 and configured to provide pressurized hydraulic fluid to power the first chute actuator 122, the second chute actuator 94, and/or the third chute actuator 78. The hopper pump may be a variable displacement pump or a fixed displacement pump. Additionally or alternatively, a pneumatic pump and/or an electrical storage and/or generation device is used to power one or more of the first chute actuator 122, the second chute actuator 94, and/or the third chute actuator 78.

Once at the job site, the concrete mixer truck 10 may be configured to dispense the material to a desired location (e.g., into a form, onto the ground, etc.). The charge hopper 42 may be repositioned into the second position from the first position by the hopper actuator 66. The extension chute(s) 48 may be extended by the third chute actuator(s) 78 to reconfigure the main chute 46 into the second configuration from the first configuration. An operator can then couple one or more removable extension chutes 68 to the distal end of the extension chute 48 to increase the overall length of the main chute 46 (as necessary). Once the main chute 46 is in the second configuration, the operator can control the first chute actuator 122 and/or the second chute actuator 94 to adjust the orientation of the main chute 46 (e.g., about a vertical axis, about a lateral axis, etc.) and thereby direct the material onto the desired location. Once the main chute 46 is in the desired orientation, the operator can control the drum driver 114 to rotate the mixing drum 14 in the second direction, expelling the material through the drum opening 72, into the discharge hopper 44, and into the main chute 46. The operator may control the speed of the mixing drum 14 to adjust the rate at which the material is delivered through the main chute 46. Throughout the process of dispensing the material, the operator can change the location onto which the material is dispensed by varying the orientation of the main chute 46 and/or by controlling the drive system 20 to propel/move the concrete mixer truck 10.

The drive system 20 is configured to propel the concrete mixer truck 10 and may drive other systems of the concrete mixer truck 10 (e.g., the drum driver 114, etc.). The drive system 20 includes driven tractive assemblies that include a front axle assembly 132 and a pair of rear axle assemblies 134, each coupled to various wheels 4. In some embodiments, the drive system 20 includes a driveshaft coupled to the front axle assembly 132 and/or the rear axle assemblies 134. The front axle assembly 132 and the rear axle assemblies 134 are coupled to the power plant module 62 through the drive system 20 such that the front axle assembly 132 and the rear axle assemblies 134 at least selectively receive mechanical energy (e.g., rotational mechanical energy) and propel the concrete mixer truck 10. In some embodiments, a pusher axle assembly 168 (e.g., tag axle assembly, etc.) is configured to be raised and lowered to selectively engage the support surface (e.g., based on the loading of the concrete mixer truck 10, etc.). Such a configuration distributes the pressure exerted on the ground by the concrete mixer truck 10, which may be required, for example, when traveling through certain municipalities under load.

The power plant module 62 (e.g., prime mover module, driver module, etc.) is configured to supply rotational mechanical energy to drive the concrete mixer truck 10. The power plant module 62 is coupled to the chassis 12 and positioned near the longitudinal center of the concrete mixer truck 10, beneath the mixing drum 14. According to an exemplary embodiment, the power plant module 62 receives a power input from the engine module 110. In some embodiments, the power plant module 62 includes a transmission and/or an electromagnetic device (e.g., an electrical machine, a motor/generator, etc.) coupled to the transmission. In some embodiments, the transmission and the electromagnetic device are integrated into a single device (e.g., an electromechanical infinitely variable transmission, an electromechanical transmission, etc.). The electromagnetic device is configured to provide a mechanical energy input to the transmission. By way of example, the electromagnetic device may be configured to supply a rotational mechanical energy input to the transmission (e.g., using electrical energy generated from the mechanical power input provided by the engine module 110, etc.). In some embodiments, the power plant module 62 and/or the drive system 20 includes additional pumps (hydraulic fluid pumps, water pumps, etc.), compressors (e.g., air compressors, air conditioning compressors, etc.), generators, alternators, and/or other types of energy generation and/or distribution devices configured to transfer the energy from the power plant module 62 to other systems.

The fuel system 108 is configured to provide fuel to the engine module 110 and/or other components of the concrete mixer truck 10. Specifically, the fuel system 108 may be configured to provide fuel to an engine 74 of the engine module 110. The engine 74 may use the fuel in an internal combustion process to generate a mechanical power output that is provided to the power plant module 62 (e.g., to generate electricity, to power onboard electric motors used to at least one of rotate wheel and tire assemblies, to drive the transmission etc.) and/or to power the drum driver 114. The fuel system 108 may include one or more valves, hoses, regulators, filters, and/or various other components configured to facilitate providing fuel to the engine 74. The fuel system 108 includes a container 126 (e.g., a vessel, reservoir, tank, etc.) that is configured to store a fluid (e.g., fuel, air, hydraulic fluid, etc.). The container 126 is disposed behind the drum driver 114 along the chassis 12. In other embodiments, the container 126 is coupled to a side of the rear pedestal 26. In some embodiments, the container 126 is coupled to the chassis 12 and positioned directly beneath the mixing drum 14. According to an exemplary embodiment, the container 126 includes a fuel tank that stores fuel used to power the engine 74. In some embodiments, the container 126 additionally or alternatively includes an air tank configured to store compressed air (e.g., for use in an air brake system, for use when raising and lowering the pusher axle assembly 168, etc.). In some embodiments, the container 126 additionally or alternatively includes a hydraulic tank configured to store hydraulic fluid for use in one or more hydraulic circuits (e.g., a hydraulic circuit that includes the drum driver 114, etc.).

A cover assembly 120 including a plurality of cover panels is positioned between the second end 38 of the mixing drum 14 and the engine module 110. The cover assembly 120 is disposed around the fuel system 108 (e.g., the container 126, etc.), the drum driver 114, and the rear pedestal 26. The cover assembly 120 is configured to protect the various internal components from debris. Such debris may be encountered while the concrete mixer truck 10 is driven along a roadway, for example. The cover assembly 120 may also protect the various internal components from damage due to collisions with trees, poles, or other structures at a jobsite or while transporting concrete. In some embodiments, all or some of the fuel system 108 is incorporated under a hood 86 of the engine module 110.

The engine module 110 is coupled to the frame rails 40 proximate the rear end 24 of the chassis 12. The engine module 110 is configured to directly, or indirectly, supply the various components of the concrete mixer truck 10 with the power needed to operate the concrete mixer truck 10. By way of example, the engine module 110 may be configured to provide mechanical energy (e.g., rotational mechanical energy) (i) to one or more components directly (e.g., via a power-take-off, etc.) to drive the one or more components (e.g., a hydraulic pump of the drum driver 114, etc.) and/or (ii) to the power plant module 62 to drive the one or more components indirectly. The engine module 110 may be defined by any number of different types of power sources. According to an exemplary embodiment, the engine module 110 includes the engine 74 coupled to the frame rails 40 and disposed within the hood 86. The engine 74 may include an internal combustion engine configured to utilize one or more of a variety of fuels (e.g., gasoline, diesel, bio-diesel, ethanol, natural gas, etc.) to output mechanical energy. In some embodiments, at least one of the drum drive motor 130, the first chute actuator 122, the second chute actuator 94, and the third chute actuator 78 is electrically driven (i.e., powered using electrical energy) rather than hydraulically driven.

In some embodiments, the engine module 110 additionally or alternatively includes multiple battery modules (e.g., batteries, capacitors, ultra-capacitors, etc.) spread throughout the concrete mixer truck 10, which cooperate to act collectively as an energy storage device. The engine module 110 can be charged through an onboard energy source (e.g., through use of an onboard generator powered by an internal combustion engine, by operating the electromagnetic device as a generator, during regenerative braking, through an onboard fuel cell, through an onboard solar panel, etc.) or through an external energy source (e.g., when receiving mains power from a power grid, etc.). In some embodiments, the concrete mixer truck 10 is a purely electric vehicle that does not include an internal combustion engine and, as such, is driven by electrical energy in all modes of operation. In such embodiments, the concrete mixer truck 10 may not include a fuel tank.

### Idle Reduction

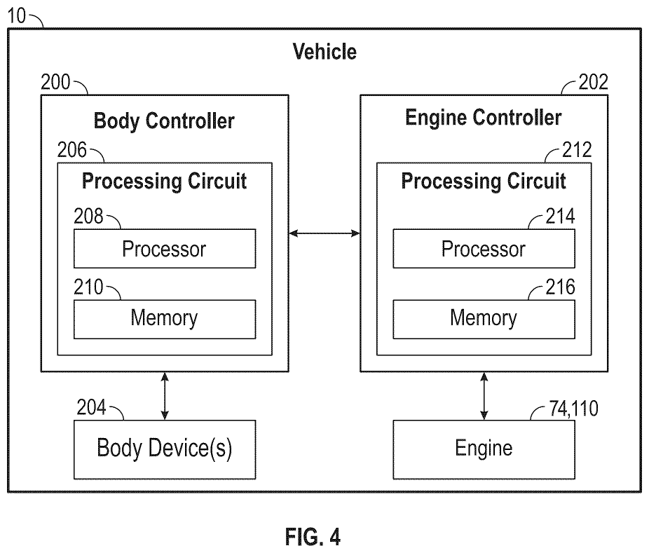

According to the exemplary embodiment shown in FIG. 4, the vehicle 10 may include one or more controllers that control the operation of the various components on the vehicle 10. By way of example, the vehicle 10 may include a body controller 200 and an engine controller 202. The body controller 200 is in communication with the body devices 204. The body devices 204 include all the components (e.g., actuators, pumps, sensors, switches, etc.) associated with operation and control of the drum assembly 6 (e.g., the mixing drum 14, the drum driver 114, etc.), the hopper assembly 8 (e.g., the main chute 46, the charge hopper 42, a discharge hopper 44, etc.), and the cab 18 (e.g., seats, a steering wheel, control panels, user interfaces, screens, joysticks, buttons, accelerator, brake, gear lever, ambient temperature outside of the cab 18, etc.). The engine controller 202 is in communication with the engine module 110, the engine 74, and the various components coupled to the engine module 110 (e.g., the drive system 20, the fuel system 118, etc.).

In some embodiments, the body controller 200 and the engine controller 202 work cooperatively to determine if a predefined shutdown criteria is met. By way of example, the body controller 200 may verify that a set of body override parameters are met and then the engine controller 202 may verify that a set of engine override parameters are met prior to performing an idle shutdown where the engine 74 transitions from an idle operating state to a shutdown state (e.g., the fuel system 118 stops providing fuel to the engine 74). In some embodiments, a single controller may control the idle shutdown process. By way of example, the body controller 200 may be in communication with the engine 74, and the body controller 200 may monitor the body override parameters and the engine override parameters, which are referred to herein as “shutdown override parameters,” to determine when to initiate an idle shutdown. In any case, incorporating the body controller 200 into the idle shutdown process avoids shutting down the engine 74 at times when, for example, the drum assembly 6 needs to be operational (e.g., with a full load of concrete).

In some embodiments, the body controller 200 includes a processing circuit 206 having a processor 208 and a memory 210. The processor 208 may be coupled to the memory 210. The processor 208 may be a general purpose or specific purpose processor, an application specific integrated circuit (ASIC), one or more field programmable gate arrays (FPGAs), a group of processing components, or other suitable processing components. The processor 208 is configured to execute computer code or instructions stored in the memory 210 or received from other computer readable media (e.g., CDROM, network storage, a remote server, etc.).

The memory 210 may include one or more devices (e.g., memory units, memory devices, storage devices, etc.) for storing data and/or computer code for completing and/or facilitating the various processes described in the present disclosure. The memory 210 may include random access memory (RAM), read-only memory (ROM), hard drive storage, temporary storage, non-volatile memory, flash memory, optical memory, or any other suitable memory for storing software objects and/or computer instructions. The memory 210 may include database components, object code components, script components, or any other type of information structure for supporting the various activities and information structures described in the present disclosure. The memory 210 may be communicably connected to the processor 208 via the processing circuit 206 and may include computer code for executing (e.g., by the processor 208) one or more of the processes described herein.

Similarly, the engine controller 202 includes a processing circuit 212 having a processor 214 and a memory 216. The processor 214 may be coupled to the memory 216. The processor 214 may be a general purpose or specific purpose processor, an application specific integrated circuit (ASIC), one or more field programmable gate arrays (FPGAs), a group of processing components, or other suitable processing components. The processor 214 is configured to execute computer code or instructions stored in the memory 216 or received from other computer readable media (e.g., CDROM, network storage, a remote server, etc.).

The memory 216 may include one or more devices (e.g., memory units, memory devices, storage devices, etc.) for storing data and/or computer code for completing and/or facilitating the various processes described in the present disclosure. The memory 216 may include random access memory (RAM), read-only memory (ROM), hard drive storage, temporary storage, non-volatile memory, flash memory, optical memory, or any other suitable memory for storing software objects and/or computer instructions. The memory 216 may include database components, object code components, script components, or any other type of information structure for supporting the various activities and information structures described in the present disclosure. The memory 216 may be communicably connected to the processor 214 via the processing circuit 212 and may include computer code for executing (e.g., by the processor 214) one or more of the processes described herein.

In some embodiments, the idle shutdown process may be a parameter that is selectively enabled or disabled, for example, by a fleet manager or on the control assembly 76 within the cab 18. If the idle shutdown parameter is enabled, an idle shutdown timer may be defined that sets that amount of time that the body controller 200 or the engine controller 202 waits to perform the idle shutdown after the override parameters are met. According to some embodiments, the shutdown override parameters may include one or more of (a) the water pump coupled to the water tank 90 being off, (b) a slump pressure is below a slump pressure threshold (e.g., a pressure measurement corresponding with the amount of hydraulic pressure required to drive the drum drive motor 130), (c) the main chute 46 and the extension chute 48 are inactive (e.g., in the storage configuration as indicated by the position of the first chute actuator 122, the second chute actuator 94, and/or the third chute actuator 78), (d) an ambient air temperature (e.g., measured by a temperature sensor of the vehicle 10) is above a lower temperature threshold, (c) an ambient air temperature is below an upper temperature threshold, (f) a hydraulic oil temperature is above an oil temperature threshold, (g) a speed of the mixing drum 14 is between a lower speed threshold and an upper speed threshold, (h) the engine 74 is at an idle speed, (i) a selected and actual gear of the transmission of the drive system 20 is neutral, (j) over-the-air programming is not in process, (k) a scale mode is inactive, (l) the vehicle 10 is not moving (e.g., as detected by a speed of the wheels 4), (m) the hood 86 is closed, (n) a hatch is closed, (o) a delivery mode is inactive, (p) a load-span tag axle calibration is inactive, (q) a load-span tag axle check is inactive, (r) a parking brake is applied and active, (s) a service brake is inactive, (t) a coolant temperature is within a predefined range of coolant temperatures, (u) transmission oil is within a predefined range of oil temperatures, (v) a low fuel light is off or inactive, (w) a battery voltage is above a predefined battery voltage threshold, (x) an override shutdown parameter has not been activated since the shutdown timer began, and/or (y) a number of active override parameters is less than a predefined number within a predefined time period.

In some embodiments, the idle shutdown timer begins to countdown to an idle shutdown if all of the shutdown override parameters (a)-(y) are met. In some embodiments, the idle shutdown timer begins to countdown to an idle shutdown when a subset of the shutdown override parameters (a)-(y) are met (e.g., two or more parameters, three or more parameters, four or more parameters, five or more parameters, etc.). According to an exemplary embodiment, the idle shutdown timer may reset and begin to countdown again if any of the shutdown override parameters (a)-(y) are not met. According to an exemplary embodiment, the idle shutdown timer may reset and not countdown again if any of the shutdown override parameters (a)-(y) are faulted. In some embodiments, the idle shutdown timer may not begin or initiate until after a cool-down timer has reset. For example, the cool-down timer may start counting down after the engine 74 starts and the cool-down timer may prevent the idle shutdown timer (and thereby an idle shutdown process) from initiating until after the cool-down timer expires. In some embodiments, the cool-down timer is set to about 5 minutes. In some embodiments, a length of time defined by the cool-down timer is user-selectable, for example, via the user interface on the control assembly 76.

According to an exemplary embodiment, once the idle shutdown timer finishes counting down without being reset, a visual indication is provided to an operator (e.g., on the control assembly 76 within the cab 18, by light or indicator within the cab 18, and/or by a light on the vehicle 10 flashes in a predefined pattern) that the engine 74 will perform an idle shutdown and the engine 74 may shutdown. In some embodiments, the visual indication is provided after the engine 74 shuts down to indicate that the engine 74 is in an idle shutdown mode, where the idle shutdown process shutdown the engine 74. In some embodiments, an audible or haptic indication may be provided in addition to the visual indication for when the idle shutdown is occurring or after an idle shutdown occurs. In some embodiments, the audible indication may be toggled on or off, for example, on the user interface of the control assembly 76. In some embodiments, once the idle shutdown timer finishes, a snooze option may be presented to an operator, for example, via the user interface of the control assembly 76. If the snooze option is activated, the idle shutdown timer may be delayed by a predefined amount of time defined by the snooze option. In some embodiments, the predefined amount of time defined by the snooze option may be longer than the ide shutdown timer. In some embodiments, the predefined amount of time defined by the snooze option is user-selectable, for example, via the user interface of the control assembly 76.

In some embodiments, one or more of the shutdown override parameters (a)-(y) may be programmable and set, for example, by a fleet manager and/or on a user interface of the control assembly 76. By way of example, the slump pressure threshold, the lower temperature threshold, the upper temperature threshold, the oil temperature threshold, the lower speed threshold of the mixing drum 14, and/or the upper speed threshold of the mixing drum 14 may be set to a value, or a range of values, as determined by the fleet manager and/or the user interface of the control assembly 76. In this way, for example, the shutdown override parameters may be adjusted depending on the time of year (e.g., adjusting ambient temperature thresholds to account for operator comfort) and/or job being completed (e.g., adjust slump pressure).

In some embodiments, the body controller 200 may include a machine learning module that monitors and calibrates the slump pressure threshold after each time the mixing drum 14 is filled with a new load to determine the slump pressure threshold that corresponds with the mixing drum 14 being empty.

### Startup After Idle Shutdown

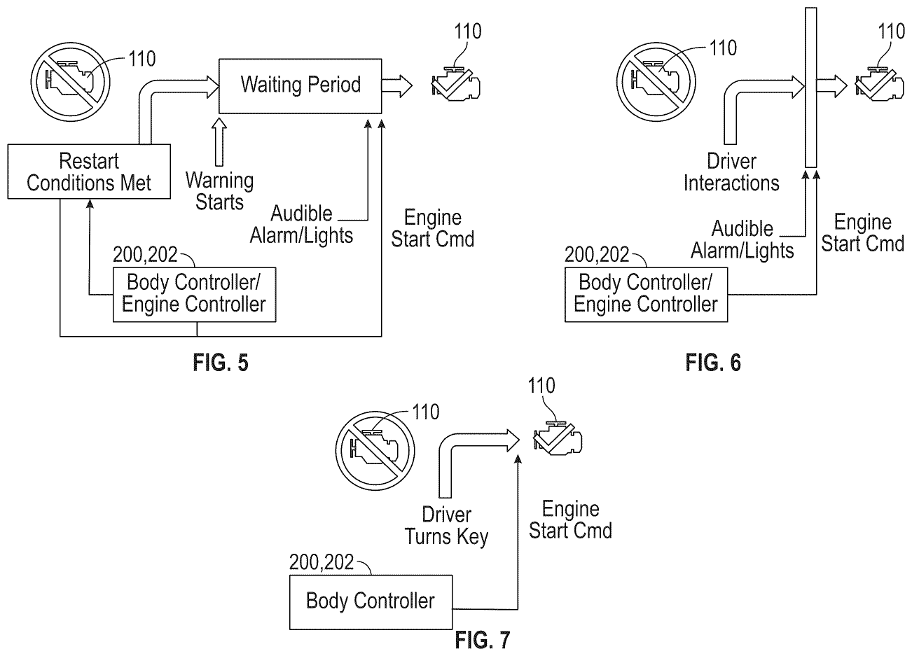

According to the exemplary embodiment shown in FIGS. 5-7, the body controller 200 may be configured to initiate a restart of the engine 74 following an idle shutdown in response to one or more restart events. In some embodiments, one or more restart override parameters may be met prior to initiating a restart in response to a restart event. By way of example, the one or more restart override parameters include one or more of (a) the engine 74 is off, (b) a parking brake is on, (c) a selected and actual gear of the transmission of the drive system 20 is neutral, (d) an accelerator pedal is not depressed, (e) a high idle mode is inactive, (f) a low fuel light is off, (g) the vehicle 10 is not moving (e.g., as detected by a speed of the wheels 4), (h) the hood 86 is closed, (i) the hatch is closed, and/or (j) none of the restart override parameters are faulted.

According to the exemplary embodiment of FIG. 5, a restart (e.g., an automatic restart) may be initiated if one or more restart events or conditions are met. In some embodiments, if any of the one or more restart override parameters (a)-(j) are broken or not met, the automatic restart outlined with respect to FIG. 5 is disabled. The one or more restart events that initiate an automatic restart may include any one of the shutdown override parameters (a)-(s) falling outside of the predefined threshold. By way of example, if any of the slump pressure, the oil temperature, and/or the ambient temperature either exceed or fall below the corresponding one of the slump pressure threshold, the lower temperature threshold, the upper temperature threshold, and/or the oil temperature threshold, a restart of the engine 74 may be triggered. In some embodiments, a restart event may include a coolant temperature dropping below a coolant temperature threshold. In some embodiments, a restart event may include a battery voltage dropping below a voltage threshold. In some embodiments, once the restart is triggered in response to a restart event, a waiting period may be initiated prior to restarting the engine 74. In some embodiments, one or more indicators are provided to an operator prior to restarting the engine 74 (e.g., an audible indication and/or a visual indication (hazard lights, etc.)).

In some embodiments, the body controller 200 and/or the engine controller 202 may monitor how long the vehicle 10 is in an idle shutdown and after a predefined time period, the vehicle may automatically or autonomously start and set a speed of the mixing drum to a predefined speed.

According to the exemplary embodiment of FIG. 6, a restart may be initiated if a predefined driver interaction is detected. By way of example, the driver interaction may include pressing a service brake for a predetermined amount of time, or interacting with a joystick of the control assembly 76 for a predetermined amount of time. By way of another example, the driver interaction may include commanding the water pump on. In some embodiments, once the restart is triggered in response to a drier interaction, a waiting period may be initiated prior to restarting the engine 74. In some embodiments, the waiting period for a restart that is responsive to a driver interaction is less than the waiting period for a restart that is response to a restart event (e.g., the automatic restart of FIG. 5).

According to the exemplary embodiment of FIG. 7, a restart may be initiated if a driver turns an ignition key. In some embodiments, the restart conditions illustrated and described with reference to FIGS. 5-7 may occur in parallel, for example, with each of the restart conditions being monitored, for example, by the body controller 200 and/or the engine controller 202 and the engine 74 being restarted with one of the various restart conditions is satisfied (e.g., automatic restart (FIG. 5), driver interactions (FIG. 6), or key switch (FIG. 7)).

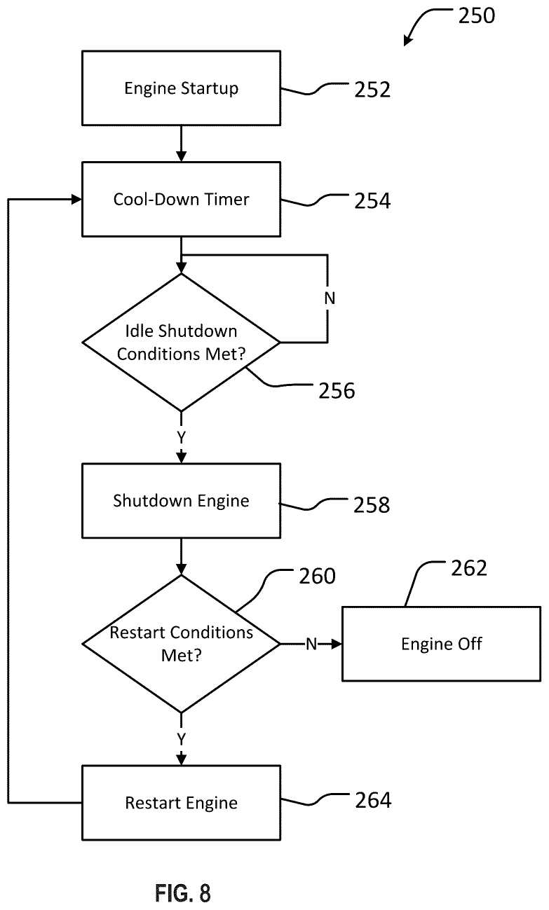

FIG. 8 illustrates an idle shutdown method or process 250 according to an exemplary embodiment of the present disclosure. In some embodiments, the idle shutdown process 250 is controlled and performed by the body controller 200, or a combination of the body controller 200 and the engine controller 202. The idle shutdown process 250 may begin, at step 252, where the engine 74 is stated or turned on. In some embodiments, the startup of the engine 74 at step 252 may be in response to one of the engine restart conditions described herein. In some embodiments, the startup of the engine 74 at step 252 may be in response to an operator or driver turning a key within the cab 18. Regardless of how the engine 74 is started at step 252, the cool-down timer is initiated, at step 254, after the engine 74 is started at step 252. In some embodiments, the body controller 200 and/or the engine controller 202 may detect the startup of the engine 74 at step 252 and initiate the cool-down timer. As described herein, the cool-down timer may include a predefined delay or countdown that prevents the engine 74 from turning off, due to the idle shutdown conditions described herein, for a predefined amount of time after a startup of the engine 74.

Once the predefined delay set by the cool-down timer is over or expired, the body controller 200 and/or the engine controller 202 may determine if the idle shutdown conditions are met at step 256. In some embodiments, determining if the idle shutdown conditions are met may begin by starting a countdown of the idle shutdown timer to countdown once all of the shutdown override parameters (a)-(y) are met. That is, the ide shutdown conditions at step 256 may be met if all the shutdown override parameters (a)-(y) are met and the idle shutdown timer finishes counting down or expires. In some embodiments, the idle shutdown timer begins to countdown when a subset of the shutdown override parameters (a)-(y) are met (e.g., two or more parameters, three or more parameters, four or more parameters, five or more parameters, etc.). That is, the idle shutdown conditions may be met if a subset of the shutdown override parameters (a)-(y) are met and the idle shutdown timer finishes counting down or expires. If the idle shutdown conditions are not met at step 256, the idle shutdown timer may reset and begin to countdown again if any of the shutdown override parameters (a)-(y) are not met.

If the idle shutdown conditions are met at step 256 (e.g., the idle shutdown timer finishes counting down without being reset by one of the shutdown override parameters (a)-(y) not being met or faulting), the engine 74 may shutdown, at step 258 from an idle condition. In some embodiments, an indication (e.g., a visual indication and/or an audible indication as described herein) is provided prior to the engine 74 shutting down at step 258. In some embodiments, an indication (e.g., a visual indication and/or an audible indication as described herein) is provided after the engine 74 shuts down at step 258.

Once the engine 74 shuts down at step 258, the body controller 200 and/or the engine controller 202 may determine, at step 260, if restart conditions are met. In some embodiments, the restart conditions are not met at step 260 if any of the one or more restart override parameters (a)-(j) are broken or not met and the engine 74 remains off at step 262. In some embodiments, the engine 74 may be automatically restarted (e.g., as described with reference to FIG. 5) and the restart conditions at step 260 may be met if any one of the shutdown override parameters (a)-(y) fall outside of the predefined threshold. By way of example, if any of the slump pressure, the oil temperature, and/or the ambient temperature either exceed or fall below the corresponding one of the slump pressure threshold, the lower temperature threshold, the upper temperature threshold, and/or the oil temperature threshold, the restart conditions may be met at step 260 and the engine 74 may be restarted at step 264. In some embodiments, the restart conditions at step 260 may be met if a coolant temperature drops below the coolant temperature threshold, and the engine 74 may be restarted at step 264. In some embodiments, the restart conditions at step 260 may be met if a battery voltage drops below the voltage threshold and the engine 74 may be restarted at step 264. In some embodiments, once the restart is triggered in response to the restart conditions being met at step 260, a waiting period may be initiated prior to restarting the engine 74 at step 264. In some embodiments, one or more indicators are provided to an operator prior to restarting the engine 74 (e.g., an audible indication and/or a visual indication (hazard lights, visual indication on the user interface of the control assembly 76, etc.)).

In some embodiments, the restart conditions are met at step 260 if one of the driver interactions are detected as described with reference to FIG. 6. In some embodiments, the driver interaction may include pressing a service brake for a predetermined amount of time, or interacting with a joystick of the control assembly 76 for a predetermined amount of time. By way of another example, the driver interaction may include commanding the water pump on. In some embodiments, the restart conditions are met at step 260 if a driver turns a key to start the engine 74 at step 264. Once the engine 74 is started at step 264, the cool-down timer may be activated and begin to countdown at step 254.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

It is important to note that the construction and arrangement of the concrete mixer truck 10 and the components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A concrete mixer vehicle comprising:
a chassis;
an engine coupled to the chassis;
a front axle coupled to the chassis;
a rear axle coupled to the chassis;
a cab coupled to the chassis, the cab defining an interior compartment;
a drum assembly coupled to the chassis, the drum assembly including:
a mixing drum defining an aperture and an internal volume;
a charge hopper positioned proximate the aperture; and
a chute positioned proximate the aperture, beneath the charge hopper;
a hopper actuator positioned to move the charge hopper between a first position and a second position, the first position facilitating loading materials into the internal volume of the mixing drum via the charge hopper through the aperture, the second position facilitating discharging the materials from the internal volume, through the aperture, and to the chute; and
a controller in communication with the engine, the drum assembly, and the hopper actuator, the controller being configured to:
detect that the engine is in an idle condition; and
selectively shutdown the engine in response to determining that one or more override conditions are met.

2. The concrete mixer vehicle of claim 1, wherein the one or more override conditions include an ambient air temperature being above a lower temperature threshold and below an upper temperature threshold.

3. The concrete mixer vehicle of claim 2, wherein the controller is configured to initiate an automatic restart of the engine, after the engine is shutdown, in response to the ambient air temperature being below the lower temperature threshold or above the upper temperature threshold.

4. The concrete mixer vehicle of claim 1, wherein the one or more override conditions include a slump pressure being below a slump pressure threshold.

5. The concrete mixer vehicle of claim 4, wherein the controller is configured to initiate an automatic restart of the engine, after the engine is shutdown, in response to the slump pressure being above the slump pressure threshold.

6. The concrete mixer vehicle of claim 1, wherein the chute includes a main chute and an extension chute pivotably coupled to the main chute.

7. The concrete mixer vehicle of claim 6, wherein the one or more override conditions include the main chute and the extension chute are in a storage configuration.

8. The concrete mixer vehicle of claim 1, wherein the one or more override conditions include a speed of the mixing drum is between a lower speed threshold and an upper speed threshold.

9. The concrete mixer vehicle of claim 1, wherein the controller is configured to initiate an automatic restart of the engine, after the engine is shutdown, in response to one or more restart conditions being met.

10. The concrete mixer vehicle of claim 9, wherein the one or more restart conditions include an ambient air temperature being below a lower temperature threshold or above an upper temperature threshold, or a slump pressure being above a slump pressure threshold.

11. The concrete mixer vehicle of claim 9, wherein the controller is configured to initiate a countdown of a cool-down timer after the automatic restart of the engine.

12. The concrete mixer vehicle of claim 11, wherein the cool-down timer prevents the engine from being shutdown by the one or more override conditions being met until the cool-down timer is expired.

13. The concrete mixer vehicle of claim 1, wherein the one or more override conditions include an ambient air temperature being above a lower temperature threshold and below an upper temperature threshold, a slump pressure being below a slump pressure threshold, a speed of the mixing drum is between a lower speed threshold and an upper speed threshold.

14. The concrete mixer vehicle of claim 13, wherein the chute includes a main chute and an extension chute pivotably coupled to the main chute.

15. The concrete mixer vehicle of claim 14, wherein the one or more override conditions include the main chute and the extension chute are in a storage configuration.

16. A concrete mixer vehicle comprising:
a chassis;
an engine coupled to the chassis;
a front axle coupled to the chassis;
a rear axle coupled to the chassis;
a cab coupled to the chassis, the cab defining an interior compartment;
a drum assembly coupled to the chassis, the drum assembly including:
a mixing drum defining an aperture and an internal volume;
a charge hopper positioned proximate the aperture; and
a chute positioned proximate the aperture, beneath the charge hopper, wherein the chute includes a main chute and an extension chute pivotably coupled to the main chute;
a hopper actuator positioned to move the charge hopper between a first position and a second position, the first position facilitating loading materials into the internal volume of the mixing drum via the charge hopper through the aperture, the second position facilitating discharging the materials from the internal volume, through the aperture, and to the chute; and
a controller in communication with the engine, the drum assembly, and the hopper actuator, the controller being configured to:
detect that the engine is in an idle condition; and
initiate an idle shutdown process where the engine is selectively shutdown in response to determining that idle shutdown conditions are met, wherein the idle shutdown conditions include (a) a slump pressure being below a slump pressure threshold, (b) a speed of the mixing drum is between a lower speed threshold and an upper speed threshold, and (c) the main chute and the extension chute are in a storage configuration.

17. The concrete mixer vehicle of claim 16, wherein the controller is configured to initiate an automatic restart of the engine, after the engine is shutdown, in response to a restart conditions being met.

18. The concrete mixer vehicle of claim 17, wherein the controller is configured to initiate a countdown of a cool-down timer after the automatic restart of the engine, wherein the cool-down timer prevents the engine from being shutdown by the idle shutdown conditions being met until the cool-down timer is expired.

19. The concrete mixer vehicle of claim 16, wherein the idle shutdown conditions further include an ambient air temperature being above a lower temperature threshold and below an upper temperature threshold.

20. An idle shutdown method for a concrete mixer vehicle, the idle shutdown method comprising:
detecting that an engine is in an idle condition; and
determining if idle shutdown conditions are met, wherein the idle shutdown conditions include (a) a slump pressure being below a slump pressure threshold, (b) a speed of a mixing drum is between a lower speed threshold and an upper speed threshold, and (c) a main chute and an extension chute are in a storage configuration;
in response to determining that the idle shutdown conditions are met, shutting down the engine.
